(19) United States
(12) Patent Application Publication
(10) Pub. No.: US 2007/0157999 A1
(43) Pub. Date: Jul. 12, 2007

(54) Flat gasket, in particular, cylinder head gasket

(75) Inventors: Hans-Peter Werner, Filderstadt (DE); Tobias Michael Gruhler, Pfullingen (DE); Peter Schenk, Hohenstein (DE); Wolfgang Fritz, Metzingen (DE); Ulrich Werz, Dettingen (DE); Matthias Baur, Roemerstein (DE); Thomas Tiefenbach, Dettingen (DE)

Correspondence Address: Edward J. Timmer, P.O. Box 770, Richland, MI, 49083, US

(73) Assignee: ElringKlinger AG

(21) Appl. No.: 11/633,706

(22) Filed: Dec. 5, 2006

(30) Foreign Application Priority Data
Dec. 14, 2005 (DE) 10 2005 059 720.3
Mar. 14, 2006 (DE) 10 2006 011 696.8

(51) Int. Cl. F16J 15/08; F02F 11/00

(52) U.S. Cl. 148/327; 277/595

(57) ABSTRACT

Flat gasket with a gasket plate which has at least one sheet metal layer which consists of a spring steel sheet, has elastic properties and is provided with at least one bead, which can be deformed elastically in its height and is subject to a dynamic pressure load under conditions of use of the flat gasket, and in order to achieve a greater operative range of the bead without reducing its durability consists of an austenitic steel according to the European standard EN 10088-2-1.4372.

The present disclosure relates to the subject matter disclosed in German application number 10 2005 059 720.3 of Dec. 14, 2005 and in German application number 10 2006 011 696.8 of Mar. 14, 2006, which are incorporated herein by reference in their entirety and for all purposes.

### BACKGROUND OF THE INVENTION

The invention relates to a flat gasket with a gasket plate which has at least one sheet metal layer which has elastic properties, consists of a spring steel sheet and is provided with at least one bead which can be deformed elastically in its height and is subject to a dynamic pressure load under conditions of use of the flat gasket.

In the following, the invention will be explained on the basis of a cylinder head gasket; the invention is, however, also suitable for other, at least essentially metallic flat gaskets, such as, for example, a flat gasket which is to be arranged between a cylinder head and an exhaust manifold of a multi-cylinder combustion engine or a different flat gasket which is to be clamped between surfaces of components and is subject during operation to a load with varying pressing forces.

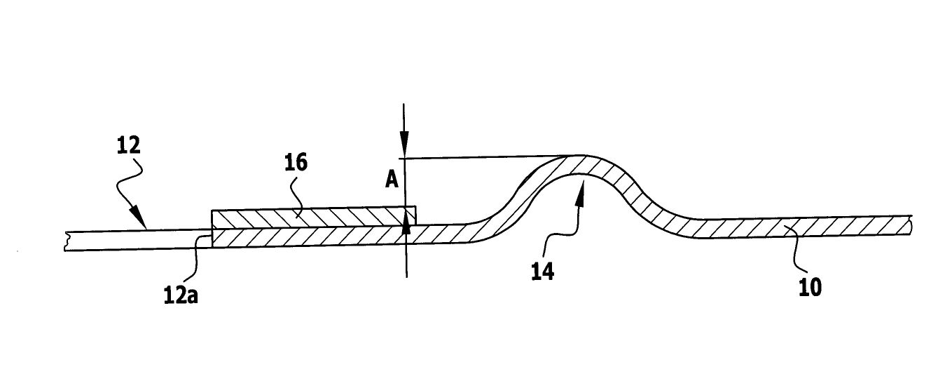

The bead in question will generally be a sealing bead, with which a seal is provided around a fluid opening (for the passage of gaseous or fluid media) of the gasket plate. The bead could, however, also be a pure supporting bead which does not serve the purpose of sealing but rather only for local support of a component sealing surface (e.g., the sealing surface of a cylinder head) when the flat gasket is clamped between sealing surfaces of components; supporting beads of this type are shown, for example, in FIGS. 1, 3, 5 and 6 of U.S. Pat. No. 5,427,389.

Finally, reference is also made to the fact that the bead can be a so-called full bead but also a so-called semi-bead—a full bead has, in cross section, the approximate shape of a circular arc, the cross section of a semi-bead corresponds to an angled step.

A bead, the height of which is elastically deformable and which is subject during operation to a varying pressure load, is subject to the risk that when it is flattened again and again to too great an extent due to relatively high pressure the bead is ruined due to the formation of cracks following a longer operating time. For this reason, it is known in the case of at least essentially metallic flat gaskets, the gasket plate of which has a single sheet metal layer or several sheet metal layers placed one on top of the other, to associate a deforming limiter, i.e., a so-called stopper with the bead, by means of which any excessive flattening of the bead during installation of the flat gasket and during operation is avoided. In the case of such a flat gasket, with which a seal is provided, for example, around a fluid opening by a bead, the height of which is elastically deformable, the stopper has, for example, the form of a sheet metal ring which is arranged next to the bead on the sheet metal layer provided with the bead and, like the latter, surrounds the fluid opening, wherein the stopper has a thickness which is less than the height of the bead so that the latter protrudes beyond the stopper to an extent which is equal to the operative range (so-to-speak equal to the range of height variation) of the bead. Above all in the case of modern reciprocating combustion engines, the variations in the width of the so-called sealing gap which is limited by the component sealing surfaces of cylinder head and engine block, between which the cylinder head gasket is to be clamped, are, however, relatively large and so the operative range of a bead must also be relatively large so that the bead can fulfill its function in any operating state.

Above all for cylinder head gaskets, up to now the gasket manufacturers have used, for the spring steel sheet layers provided with beads, almost exclusively a spring steel sheet consisting of an austenitic steel according to the European standard EN 10088-2-1.4310—such steel contains apart from carbon, silicon, manganese and chromium at least 6% nickel.

### SUMMARY OF THE INVENTION

It has now surprisingly been ascertained at the company ElringKlinger AG that the operative range of a bead with otherwise the same dimensions may be increased without reducing the durability of the bead in that a similar steel is used for the spring steel sheet which contains somewhat less nickel but somewhat more manganese than the steel according to the European standard EN 10088-2-1.4310, namely an austenitic steel according to the European standard EN 10088-2-1.4372. In accordance with the invention, the spring steel sheet for a flat gasket of the type mentioned at the outset consists, therefore, of an austenitic steel according to the European standard EN 10088-2-1.4372. As a result, the operative range of a sealing bead may be increased by in the order of magnitude of 1 to 2 μm with otherwise the same dimensions, i.e., in the case of a cylinder head gasket, a value which would appear to be small but in view of the size of the temporal variations in the width of the sealing gap is not inconsiderable. Furthermore, the durability of a bead may be improved as a result of the invention, namely in comparison with a bead with an equally large operative range. As a result of the present invention, not only the durability and/or the operative range of a bead, the height of which is elastically deformable, may be increased but the material costs required for a flat gasket of the type mentioned at the outset may also be decreased since nickel is a relatively expensive alloy element, the proportion of which is smaller in relation to a steel sheet according to the European standard EN 10088-2-1.4310—manganese is considerably cheaper than nickel and so despite a higher proportion of manganese in the sheet steel to be used in accordance with the invention the production costs of a flat gasket can be reduced with use of the present invention.

In the case of preferred embodiments of the flat gasket according to the invention, a steel sheet is used for the sheet steel layer provided with the at least one bead which is cold rolled in such a manner that its tensile strength corresponds approximately to the strength class C1300; in particular, the tensile strength should be between 1350 and 1500 N/mm², the tensile yield should amount to at least 1050 N/mm² and the elongation A80 defined by the standard 5 to 22%.

With respect to their properties, flat gaskets according to the invention are particularly preferred, with which the steel has the following chemical composition:

| | |
|---|---|
| C max | 0.15% |
| Si max | 1.0% |
| Mn | 5.5-7.5% |
| P max | 0.045% |
| S max | 0.015% |
| N | 0.05-0.25% |
| Cr | 16.0-18.0% |
| Ni | 3.5-4.5%, |

the remainder being Fe.

### BRIEF DESCRIPTION OF THE DRAWING

In the following, additional features of the invention will be explained, namely on the basis of the attached drawing which shows a section through part of a sheet metal layer of a flat gasket according to the invention.

### DETAILED DESCRIPTION OF THE INVENTION

The drawing shows part of a sheet metal layer 10, from which an opening 12 has been stamped which is illustrated only partially and is, in particular, circular, this opening being, for example, a combustion chamber opening of a cylinder head gasket. A sealing bead 14 designed as a full bead is impressed into the sheet metal layer 10, namely at a distance from the edge 12a of the opening 12, and a sheet metal ring is placed on the sheet metal layer 10 between the edge 12a of the opening and the bead 14 and secured to the sheet metal layer 10 by, for example, point welding, this ring surrounding the opening 12 likewise in a circular shape and forming a stopper 16 which protrudes beyond the bead 14 by the measurement A which corresponds to the operative range of the bead 14.

In a preferred embodiment, the steel of the sheet metal layer 10 has the following chemical composition (wherein only the essential alloy components, besides Fe, are specified):

| C | N | Mn | P | S | Si | Cr | Ni |
|---|---|---|---|---|---|---|---|
| 0.10 | 0.10 | 6.30 | 0.028 | 0.0005 | 0.46 | 16.40 | 3.90 |

1. Flat gasket with a gasket plate having at least one sheet metal layer consisting of a spring steel sheet and having elastic properties, said layer being provided with at least one bead deformable elastically in its height and subject to a dynamic pressure load under conditions of use of the flat gasket, wherein the spring steel sheet consists of an austenitic steel according to the European standard EN 10088-2-1.4372.

2. Flat gasket as defined in claim 1, wherein the sheet steel used for the sheet metal layer is a sheet steel cold rolled in such a manner that its tensile strength corresponds to the strength class C1300.

3. Flat gasket as defined in claim 1, wherein the steel has the following chemical composition:

| | |
|---|---|
| C max | 0.15% |
| Si max | 1.0% |
| Mn | 5.5-7.5% |
| P max | 0.045% |
| S max | 0.015% |
| N | 0.05-0.25% |
| Cr | 16.0-18.0% |
| Ni | 3.5-4.5%, |

the remainder being Fe.

4. Flat gasket as defined in claim 1, wherein the bead is a full bead.

5. Flat gasket as defined in claim 1, wherein a stopper limiting the flattening of the bead is associated with it.
